(19) United States
(12) Patent Application Publication
(10) Pub. No.: US 2025/0372934 A1
(43) Pub. Date: Dec. 4, 2025

(54) ULTRAHIGH FIBER LASER SYSTEM WITH CONTROLLABLE OUTPUT BEAM INTENSITY PROFILE

(71) Applicant: IPG PHOTONICS CORPORATION, Marlborough, MA (US)

(72) Inventors: Eugene SCHERBAKOV, Burbach (DE); Valentin FOMIN, Burbach (DE); Andrey ABRAMOV, Burbach (DE); Mikhail ABRAMOV, Burbach (DE); Dmitry JAGODKIN, Burbach (DE)

(73) Assignee: IPG PHOTONICS CORPORATION, Marlborough, MA (US)

(21) Appl. No.: 19/047,024

(22) Filed: Feb. 6, 2025

Related U.S. Application Data
(63) Continuation-in-part of application No. 17/299,490, filed on Jun. 3, 2021, now Pat. No. 12,237,642.
(60) Provisional application No. 62/774,846, filed on Dec. 3, 2018.

(51) Int. Cl. H01S 3/067

(52) U.S. Cl. CPC H01S 3/06737; H01S 3/06745

(57) ABSTRACT

The disclosed ultra-high power all fiber laser system is configured with multiple spaced apart fiber lasers outputting respective laser beams respective paths. The disclosed system is further configured with a tapered fiber-bundle including at least one central guiding fiber and a plurality of peripheral guiding fibers. The disclosed system further has a multicore delivery fiber provided with at least two concentric and radially spaced apart central and peripheral cores. The peripheral core is coupled to the peripheral guiding fibers while the central core is spliced to the central guiding fiber so that a system outputs beams emitted from respective central and peripheral core of the delivery fiber having a different beam shape from the system output emitted from the outer core.

### CROSS-REFERENCE TO RELATED APPLICATIONS

This application is a continuation in part of U.S. patent application Ser. No. 17/299,490, filed Jun. 3, 2021, which is a 371 of PCT/US2019/064251, filed Dec. 3, 2019, which claims the benefit of U.S. Provisional Application No. 62/774,846 filed on Dec. 3, 2018, each of which is hereby incorporated by reference in its entirety.

### BACKGROUND OF THE DISCLOSURE

### Field of the Disclosure

The disclosure relates to ultrahigh all-fiber laser systems. In particular, the disclosure relates to an ultrahigh power all fiber laser system operative to deliver beams with different intensity distribution profiles simultaneously or sequentially.

### Background of the Disclosure

Ultrahigh fiber laser systems are known to output multi-kW high brightness output light. A typical high power fiber laser system has a large footprint since it includes multiple fiber laser modules which are combined together, and therefore is not easily maneuverable. Yet oftentimes it is necessary to deliver high power light to a remote, difficult to access location. For this reason, high power laser systems have a long delivery fiber which may be detrimental to the quality of light and fiber integrity due to numerous nonlinear effects.

The term “nonlinear”, in optics, means intensity-dependent phenomena. Nonlinear effects in optical fibers occur due to (1) change in the refractive index of the medium with optical intensity, and (2) inelastic scattering phenomenon. The nonlinear effects depend on the transmission length. The longer the fiber link length, the more the light interaction and greater the nonlinear effect. The other factor affecting nonlinearities in fibers is intensity, and the intensity is inversely proportional to area of the core. The higher the intensity, the greater the nonlinear effects. These factors are invariably present in high power fiber laser systems and can detrimentally affect the system's output by decreasing both its power and quality.

Often various solutions for cutting and welding material require various beam intensity profiles of the output beam. For example, it has been observed that cutting of metal can be performed at a much lower power, higher cutting speed and quality when using a “doughnut”-shaped profile instead of more conventional beam profiles, such as a “ring”-shaped profile. The “donut”-shaped is characterized by a relatively high intensity around the core's periphery and a relatively low intensity along the core's central (or axial) region.

Fiber laser systems configured with multiple fiber laser sources, which have respective output fibers combined into a single delivery fiber certainly can meet this requirement. The combined output fibers outputting respective beams with different beam profiles are advantageous for a variety of industrial applications. For example, it has been observed that cutting metal of a given thickness can be performed at a much lower power, higher cutting speed and increased quality when using a doughnut beam instead of more conventional beam profiles.

U.S. Pat. No. 8,781,269 (US '269) discloses various arrangements to selectively couple several input beams from respective light sources into a multi-clad fiber to generate different beam shapes of an output laser beam. The input beams propagate through free space and bulk switching optics before being electively coupled into the desired core and cladding regions of the feeding multi-clad fiber. The electivity is realized by the switching optic such that only one of multiple input beams can be coupled into the delivery fiber. The lasers disclosed in this reference are typically deployed in heavy industries associated with high mechanical and thermal stresses which are detrimental to optical systems utilizing bulk components. Furthermore, the light beams propagating through the bulk optics experience losses due to the reflection of the lens surface. Another factor that contributes to the decrease of the transmitted optical power through a lens is light scattering by surface roughness and glass imperfection within its volume.

U.S. Pat. No. 7,130,113 teaches the arrangement similar to that of US '269 in which fiber to optic bonding has been taught by using a bulk optic, such as a lens. Such a coupling tends to compensate for collimating effects.

WO2016198724 (WO '724) teaches propagating multiple individually controllable laser beams through one coaxial ring fiber, but in contrast to US '269, there are no bulk switching optics because the disclosed laser is an all-fiber design. The reference discloses a laser beam insert having central and peripheral channels which are traversed by respective delivery fibers further sliced to the cores and at least one cladding of the delivery fiber. The configuration of the combiner is complex and thus labor and cost ineffective.

The applicant has previously engaged in development of multibeam laser systems disclosed in WO 2016/025701US and WO 2016/200621 which are filed in Aug. 13, 2014 and May 26, 2015, respectively and fully incorporated herein by reference.

A need therefore exists for an ultra-high power all fiber laser with a long delivery fiber configured to output the ultra-high power laser beam in the remote locations.

Another need exists for the ultra-high power all fiber laser system having a simple configuration which allows providing a controllable composite output beam.

### SUMMARY OF THE DISCLOSURE

These needs are satisfied by the disclosed ultra-high power all fiber laser system which includes numerous fiber laser sources which are only limited by practical considerations. The laser sources are arranged to have one or more central lasers sources and other multiple laser sources, referred to as peripheral sources, which may flank, surround or just simply be spaced from the central source(s) without any specific order.

The laser sources generate respective laser outputs guided along light paths through respective central and peripheral source output fibers, the downstream ends of which are spliced to respective feeding fibers. To prevent significant losses, the core ends of respective spliced output and feeding fibers are aligned with one another and uniformly dimensioned.

The feeding fibers are coupled to a tapered fiber-bundle including a plurality of guiding fibers which are fused together to define a fiber combiner. The fiber combiner, as known to one ordinary skill, is configured with a central guiding fiber, which is spliced to the downstream end of the central feeding fiber, and a plurality of peripheral guiding fibers surrounding the central guiding fiber and butt-spliced to respective peripheral feeding fibers. Structurally, thus, the fiber combiner has a large input face and an output face that is smaller than the input face.

In the disclosed system, the output face of the fiber combiner is spliced to a multicore delivery fiber, which allows light guided through peripheral fibers to be coupled into at least one second core while the light propagating through a train of spliced central fibers is coupled into the central core of the delivery fiber. The longitudinal cross-section of the delivery fiber has preferably a double bottleneck shape which is configured with two relatively small input and output ends, a middle portion with a diameter larger than that of each end, and two tapered portion bridging the opposite ends of the middle portion and respective input and output ends. The disclosed structure allows the delivery fiber to be much longer than those of the prior art since the threshold for nonlinear effects is higher than the threshold observed in uniformly dimensioned delivery fibers due to the enlarged core diameter of the central portion. However, regular uniformly shaped fibers may be used as well subject to the above-disclosed limitations.

The disclosed all fiber laser system includes multiple laser sources having respective feeding fibers which, in contrast to WO '724, are coupled together into a tapered combiner which is configured with one central fiber end and multiple peripheral fiber ends. The tapered combiner is directly spliced to a multicore delivery fiber which has the cores of respective central and peripheral fibers aligned with central and peripheral cores of the fiber combiner. The output end of the delivery fiber is in optical and mechanical contact with a quartz block. The all fiber connection between the feeding and delivery fibers eliminates the need in a complicated and labor-intensive fiber coupler of WO '724. Controlling the outputs of respective laser sources allows the delivery fiber to output a beam having a variety of beam shapes.

The laser sources can be configured as multimode, single mode or a combination of MM and SM sources, polarized and non-polarized sources. The laser sources are not limited to any particular power level and thus operate in a very broad range of powers from a few watts to hundreds of kW and, depending on the operational regime of any given laser source, up to one or more MWs. The operational regime may be selected from continuous wave (CW), quasi-continuous (QCW) and pulsed laser operations. The operational regimes within the scope of the disclosure may include all laser sources operating simultaneously or sequentially in the same operational regime or different operational regimes. Preferably, a laser source is a fiber laser, but pigtailed diode lasers, YAGs, disc lasers and any possible combination of laser configurations are within the scope of this disclosure. Common to all laser modifications covered by this disclosure is a fiber delivery system necessarily configured with a multi-core delivery fiber. All of the above-disclosed laser configurations, as well as features disclosed above and discussed in detail below can be used in any combination with one another without deviating from the claimed subject matter of this disclosure.

### BRIEF DESCRIPTION OF THE DRAWINGS

The above and other features of the disclosed fiber laser system will become more readily apparent from the specific description accompanied with the following drawings, in which:

FIG. 1 is a diagrammatic view of the disclosed fiber laser system configured in accordance with one modification;

FIG. 2 is a diagrammatic longitudinal section of the disclosed laser system configured in accordance with another modification;

FIG. 3 is a cross-sectional view of the delivery fiber of FGs. 1 and 2 and a refractive index profile thereof;

FIG. 4A is a cross-sectional view of the output face of the 7×1 fiber combiner;

FIG. 4B is a cross-sectional view of the delivery fiber of FIGS. 1-3;

FIG. 4C is the interface between spliced ends of the combiner and delivery fiber respectively;

FIG. 4D is a refractive index profile of the delivery fiber of FIG. 4B;

FIGS. 5A-5D correspond to respective views of FIGS. 4A-4D but for the 19×1 fiber combiner.

FIGS. 6A and 6B illustrate the cross-sectional views of the interface between the delivery fiber of FIGS. 1 and 2 and the combiner, provided with three central fibers.

FIGS. 7A and 7B are similar to respective FIGS. 6A and 6B but with combiner having seven central fibers.

### SPECIFIC DESCRIPTION

Reference will now be made in detail to the embodiments of the invention. Wherever possible, same or similar reference numerals are used in the drawings and the description to refer to the same or like parts or steps. The drawings are in simplified form and are not to precise scale. For purposes of convenience and clarity only, directional (up/down, etc.) or motional (forward/back, etc.) terms may be used with respect to the drawings. The term “couple” and similar terms do not necessarily denote direct and immediate connections, but also include connections through intermediate elements or devices.

In accordance with the inventive concept shown in FIGS. 1, 2 and 3, the disclosed ultra-high power all fiber laser system 10 may include any number of fiber laser sources 14p-14c limited only by practical considerations. The laser sources 14 are arranged in a configuration having one or more central lasers sources 14c and multiple peripheral laser sources 14p which may flank, surround or just simply be spaced from the central source(s) without any specific order. The operational regime of laser sources 14 may be selected from one of continuous wave (CW) or quasi CW (QCW) or pulsed regimes. The scope of the disclosure provides for laser sources 14 operate in respective different regimes or all source may have the same regime. For example, central laser 14c may be a QCW laser, whereas peripheral laser sources 14c can operate in a CW regime. The laser sources may output respective laser beams simultaneously or sequentially in a single transverse mode (SM) or multiple transverse modes (MM) which necessitates either SM fibers or MM fibers. The configuration including a combination of SM and MM laser sources along with respective SM and MM fibers is also contemplated within the scope of this disclosure. The output powers of respective laser sources 14 may be either the same or different from one another. The laser sources are controlled by a central processing unit 12 in a manner known to one of ordinary skill in software and laser arts.

The laser sources 14 generate respective laser outputs guided along light paths through respective central and peripheral output fibers 16c and 16p, the downstream ends of which are spliced to respective feeding fibers 18c and 18p. To prevent losses, the cores of respective spliced output and feeding fibers are aligned with one another and uniformly dimensioned.

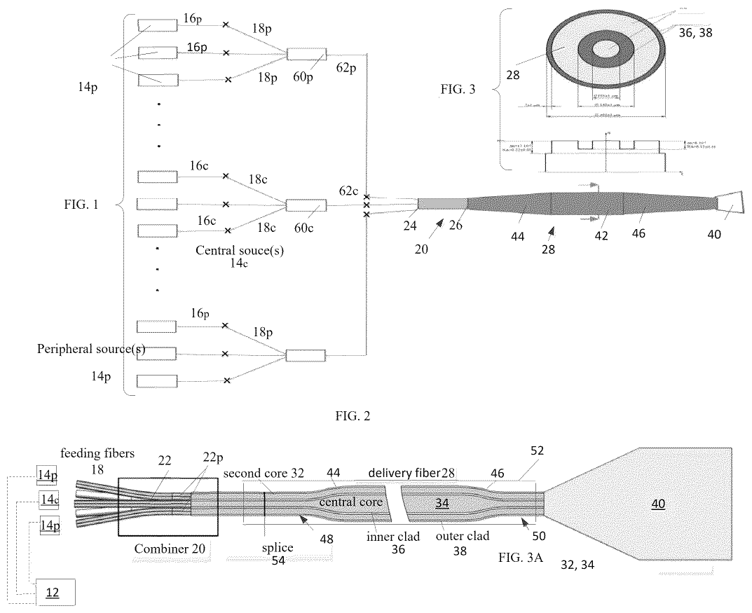

The feeding fibers 18p and 18c are coupled to a tapered fiber-bundle including a plurality of guiding fibers which are fused together to define a downstream fiber combiner 20. The fiber combiner, as known to one ordinary skill and shown in FIG. 2, is configured with a central guiding fiber 22c, which is spliced to the downstream end of central feeding fiber 18c, and a plurality of peripheral guiding fibers 22p surrounding central guiding fiber 22c and spliced to peripheral feeding fibers 18p. The input and output faces 24 and 26, respectively, define therebetween the body of combiner 20.

In the disclosed system, output face 26 of downstream fiber combiner 20 (FIG. 1) is spliced to a multicore delivery fiber 28, which allows light guided through peripheral fibers 16p, 18p and 22p to be coupled into at least one second core 32 while the light propagating through a train of spliced central fibers 16c, 18c and 22c is coupled into a central core 34 of the delivery fiber. The central and second cores 34, 32 respectively are separated by an inner cladding 36 which along with outer clad 38 sandwiches second core 32. Depending on the number of feeding fibers 18,

FIG. 4A illustrates a cross-sectional view of the input face of 7×1 downstream fiber combiner 20 provided with a central fiber 20c and six (6) peripheral fibers 20p. The combiner's fibers 22c, 22p are spliced to respective outputs of feeding fibers 18. The two-core delivery fiber 28 illustrated in FIG. 4B has central core 34 having a diameter which is substantially equal to that of central guiding fiber 22c. Alternatively, central core 34 may have a core diameter which is greater than that of central guiding fiber 22p, so that central core 34 radially overlaps at least those peripheral guiding fiber 22p which are in radial mechanical contact with central guiding 22c. The central core 34 of delivery fiber 28 may optionally overlap peripheral guiding fibers 22p which are radially spaced from central guiding fiber 22c. The second core 32 of delivery fiber 28 is dimensioned to receive peripheral guiding fibers 22p of combiner 20, as shown in FIG. 4C. The refractive index profile of delivery fiber 28 is illustrated in FIG. 4D.

FIGS. 5A-5D illustrate respective views corresponding to the views of respective FIGS. 4A-4D. However, the shown configurations of combiner 20 includes nineteen (19) guiding fibers 20c and 20p arranged concentrically with the inner circle, which corresponds to central guiding fiber 20c, and the outer circle having twelve (12) peripheral guiding fibers 20p. The increased number of the guiding fibers may cause the modification of delivery fiber 28. As illustrated in FIGS. 5B and 5D, the latter is configured with central core 34 and two second cores 32 and 35. Three cladding 36, 38 and 39 compete the configuration of FIG. 5B. Similar to the configuration of FIGS. 4A-4D, the core diameters of respective guiding fiber 20c and central core 34 of delivery fiber 28 are dimensioned to match one another. However, as shown in FIGS. 4C, 5C and FIGS. 6A and 7A, delivery fiber 28 may have a diameter which is greater than that of output face 26 (FIG. 1) of combiner 20.

Referring briefly to FIGS. 4D and 5D, refractive indices n₁ of respective central core and second core(s) are illustrated to be equal to one another. However, the scope of the disclosure covers central and second cores configured with respective indices which differ from one another. Similarly, while inner and outer cladding 38, 36 and 39 are shown to have with a uniform refractive index n₂, it is foreseen that the cladding may have respective refractive indices not equal to one another.

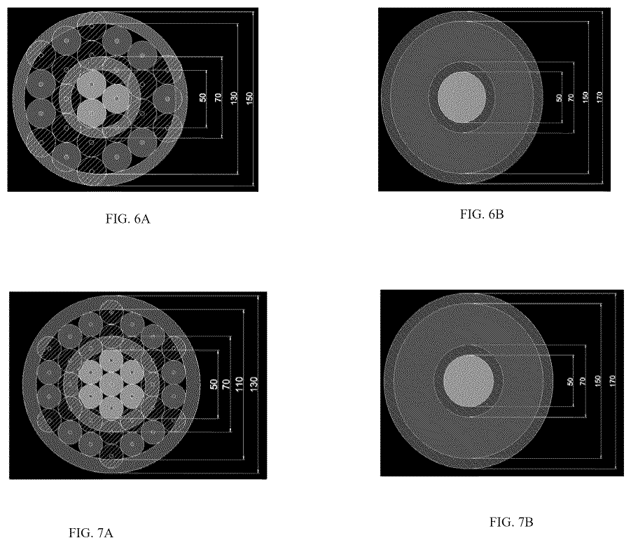

FIGS. 6A and 6B illustrate the cross-sectional views of combiner 20 and delivery fiber 28, respectively. The difference between this modification and those shown in FIGS. 4 and 5 includes a different multiple central fibers 20c of combiner 20. In particular, three (3) central fibers 20c together define an outer circumference matching or being smaller than the core diameter of central core 34 of delivery fiber 28.

FIGS. 7A-7B are analogous to FIGS. 6A-6B respectively. However, fiber combiner 20 has a central zone defined by seven 7 central fibers 20c which define an outer circumference matching the core diameter of central core 32 of delivery fiber 28. Twelve guiding peripheral fibers 20p are spliced to second core 32 of delivery fiber 28 and, similar to all previously disclosed modifications, may radially extend into neighboring regions of respective claddings 36, 38 of delivery fiber 28. Note that central fibers 20c together are arranged in at least one circle having its diameter which either matches or smaller than that of the input end of central core 34. Depending on the number of central guiding fibers 20c, it is possible to have a plurality of concentric arrangements of central guiding fibers. In this case, the core diameter of the input end of delivery fiber 28 can overlap more than one concentric arrangement of central guiding fibers.

As readily understood by one of ordinary skill in the laser arts, the number of central fibers 20c of combiner 20 may be increased. The increased number of central fibers 20c, in turn, may require the increased core diameter of central core 34 of delivery fiber 28. The core diameter of central core 34 of delivery fiber 28 may vary between 50 μ and 100 μ, whereas the outer diameter of delivery fiber 28 may range between 150 μ and 300 μ. These ranges, of course, are exemplary and may be adjusted in accordance with any given requirements.

FIGS. 1 and 2 set forth an exemplary schematic of the present invention, whereby a laser system 10 delivers multiple different outputs from respective lasers 14₁-14ₙ through respective feeding optical fibers 18₁-18ₙ which, as will be disclosed below, surround a central delivery fiber 20. The downstream ends of respective feeding fibers form a combiner which is disclosed below as directly spliced to the upstream end of a multi-core delivery fiber 24. The latter, in turn, is fused to an end block 26 made of quartz.

The lasers 14₁-14ₙ may be enclosed in a console 12 or placed at respective different locations. The lasers, as disclosed above, may have identical or different structures with similar or different characteristics and operate in the same or different operational regimes.

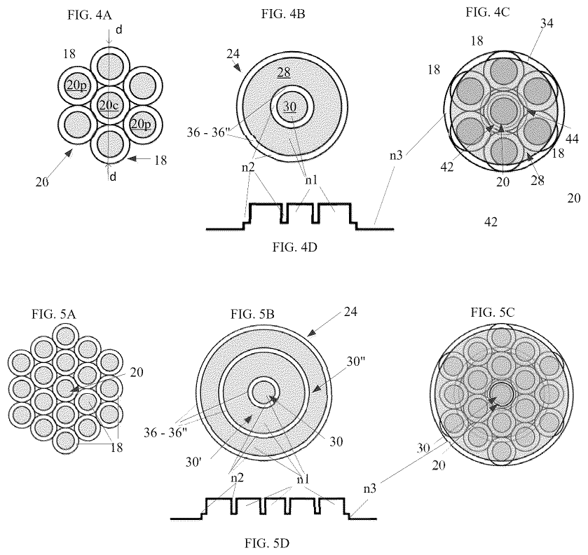

Referring to FIGS. 3 and 4, multiple output ends of respective feeding peripheral fibers and central fiber 20 are coupled together to form a 7-component combiner 25 or 19-component combiner (FIGS. 5A, 5C and 6) or any other reasonable number of these components which is shaped to have a tapered intermediate section 27 and generally cylindrical end section 29 in a manner known to one of ordinary skill in the fiber laser arts. The reduction of the outer dimeter D-D which is determined by the outer peripheries of spaced and co-extending feeding fibers 18 to the outer diameter d of end section 29 (FIG. 3A) may vary within a 2-10 times range. The determining factors of the actual reduction include alignment and dimension of (1) reduced central core 20′ (FIG. 3A) of central feeding fiber 20 (FIG. 4) and core 30 (FIG. 3B) of delivery fiber 24, and (2) cores 18′ (FIG. 3A) of respective peripheral feeding fibers 18 (FIG. 4) and cladding 28 (FIG. 3B) of delivery fiber 24. In case of configuration of FIGS. 5 6, peripheral fibers 18 adjoining the central fiber 20 should be aligned with core 30′ delivery fiber 24 (FIG. 5B), and peripheral feeding fibers 18 surrounding those adjacent to the central core are aligned to core 30″ of delivery fiber 24, and etc. Note that in FIGS. 3-4 end sections 29 of respective adjacent delivery peripheral fibers 18 are all in mechanical contact with one another and with central end section of feeding fiber 20. In FIGS. 5, 6 the end sections of respective “outer” adjacent peripheral fibers 18, i.e., those feeding fibers 18 that are spaced radially from central feeding fiber 20, are obviously in contact with one another and with respective end sections of adjacent “inner” feeding fibers. Completing the entire structure is a protective sleeve 34 of polymer material covering the splice region between combiner 25 and delivery fiber 24 in a known to one of ordinary skill manner.

The delivery fiber 24 is configured with two core regions 28, 30 respectively of FIG. 3B (or three core regions 30-30″ of FIG. 5B or more). The core regions are concentric have the same refractive index n1 which is higher than refractive index n2 of each of inter-core concentric regions 36-36″ as shown inn FIGS. 3D and 5D dividing the core regions.

Referring to FIG. 3E in combination with FIG. 3C, instead of single central fiber 20, multiple fibers 20, 42 and 44 may be used. These fibers are positioned concentrically to guide the beam from the same or different laser sources (not shown). The peripheral fibers 18-18″ surround outer central fiber 44 in a manner similar to that of FIG. 3A. The configuration shown in FIG. 3E can obviously be utilized in the configuration shown in FIGS. 5A-5D.

In use, controlling the lasers' output, light signals can be selectively guided through respective cores 18′ of feeding fibers 18 (FIGS. 3A, 4, 5A and 6) and coupled into the desired core or cores of delivery fiber 24. As a result, delivery fiber outputs the system beam having the desired shape. The shape of the beam incident on the workpiece to be laser treated may be only a full central circuit, if only one or more central feeding fibers are utilized without the help of peripheral delivery fibers; or only multiple donut-shape beam or beams or the former and latter together. Preferably, but not necessarily, all fibers of the combiner of FIGS. 4 and 6 are multimode (MM) fibers. Alternatively, only central fiber 20 is MM whereas all peripheral fibers 18 are single mode (SM) fibers. Obviously other combinations of MM and SM fibers can be utilized to match the required task.

One advantageous combination of laser sources 14_₁-14ₙ of FIG. 1 may include a “central” laser which operates in a quasi-continuous (QCW) regime, whereas the “peripheral” lasers each output a CW beam. The central and peripheral lasers may operate simultaneously or sequentially. The QCW laser may be used, for example, as a piercing tool, whereas the CW peripheral lasers can be used for cutting. In the configuration of FIGS. 3C and 3E, both the piercing and cutting of the working piece may be performed by utilizing central concentric feeding fibers. Other possible combinations of operational laser regimes may include pulsed lasers in combination with either CW of QCW lasers. The peripheral lasers may be selectively utilized with one or more peripheral lasers not outputting beams.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

The invention claimed is:

1. A high-power all fiber laser system, comprising:
a tapered fiber bundle including one or more central and one or more peripheral guiding fibers which selectively receive respective laser beams, guided along respective light paths, and have respective downstream ends fused to one another so as to define an output end of the tapered fiber bundle; and
a multicore delivery fiber having an input end, which is spliced to the output end of the tapered fiber bundle, and an output end, the multicore delivery fiber being configured with:
a central core having an input core end which is spliced to the central guiding fiber and dimensioned with a core diameter which matches or is greater than a diameter of the downstream end of the central guiding fiber or fibers, and
a peripheral core concentric with and spaced radially from the central core, an input end of the peripheral core being spliced to the downstream end of the peripheral guiding fiber or fibers,
wherein the central guiding fiber or fibers and central core of the delivery fiber define a first fixed path for the laser beam having a ring shape at the output end of the delivery fiber, and the peripheral guiding fiber or fibers and peripheral core of the delivery fiber define a second fixed path for the laser beam having a donut-shaped beam at the output end of the delivery fiber.

2. The high-power fiber laser system of claim 1 further comprising:
one or more central fibers laser sources selectively outputting respective laser beam which are coupled into and guided in respective central feeding fibers, output ends of respective central feeding fiber being coupled to respective central guiding fibers,
one or more peripheral fibers laser sources selectively outputting respective laser beams which are coupled into and guided along respective peripheral feeding fibers, output ends of respective peripheral feeding fibers being spliced to respective peripheral guiding fibers.

3. The high-power fiber laser system of claim 1, wherein the multicore delivery fiber has a uniform diameter between the input and output ends thereof.

4. The high-power fiber laser system of claim 1, wherein the multicore delivery fiber having
a mid-portion extending between the input and output ends of the delivery fiber and configured with a diameter which is larger than that of the input and output ends, and
input and output tapered portions bridging input and output ends with respective opposite ends of the mid-portion.

5. The laser system of claim 2 further comprising a plurality of second fiber combiners each combining a group of feeding fibers so that the central feeding fibers are combined in a central second fiber combiner while the peripheral feeding fibers are combined in a plurality of peripheral second fiber combiners, the second central and peripheral fiber combiners having respective output fibers spliced to the central and peripheral guiding fibers of the combiner.

6. The laser system of claim 2 further comprising a controller coupled to and selectively energizing the fiber laser sources so that
only the central fiber laser sources selectively emit a laser beam propagating along the first fixed path into the central core of the delivery fiber, or
only the peripheral fiber laser sources emit respective laser beams propagating along the second fixed path and coupled into the second core of the delivery fiber, or
the central and peripheral fiber laser sources emit respective laser beams coupled into the respective central and second cores of the delivery fiber, wherein the laser beam outputs from the central and second cores of the delivery fiber have respective different beam intensity profiles.

7. The laser system of claim 1 further comprising a quartz beam expander fused to the output end of the delivery fiber.

8. The laser system of claim 2, wherein the central and peripheral laser sources all operate in the same regime or different regimes, the regime including a continuous wave (CW), quasi-QW (QCW) or pulsed or a combination of different regimes.

9. The laser system of claim 8, wherein the peripheral fiber laser sources operate in a CW regime, while the central fiber laser source operates in a QCW regime.

10. The laser system of claim 2, wherein the central and peripheral fiber laser sources are energized simultaneously with one another or the central fiber laser source is energized before or after the peripheral fiber laser sources.

11. The laser system of claim 2, wherein the central and peripheral laser sources output respective laser beams in a single transverse mode (SM) or multimode (MM), the laser sources each having a master oscillator power fiber amplifier (MOPFA) configuration.

12. The laser system of claim 1, wherein the central and peripheral cores of the delivery fiber have respective refractive indices and are separated by an inner cladding which is configured with a refractive index lower than refractive indices of respective central and peripheral cores.

13. The laser system of claim 12, wherein the delivery fiber is configured with one central and plurality of concentric and radially spaced apart peripheral cores alternating with respective claddings, the refractive indices of respective central and peripheral cores of the delivery fiber being equal to or different from one another, and the refractive indices of respective claddings being equal to or different from one another.

14. The laser system of claim 1, wherein the combiner has a 3×1, 7×1, 19×1 or 38×1 port configuration, a diameter of the central core of the delivery fiber ranging between 50 μm and 100 μm, the peripheral core having a core diameter varying from 100 μ to 300 μ.

15. The laser system of claim 1 further comprises a protective sleeve surrounding the combiner and extending beyond the input and output faces to protect coupling regions between the combiner and feeding fibers and between the combiner and delivery fiber respectively, the protective sleeve being made from a polymer with a refractive index lower than that of the inner and outer claddings of the delivery fiber.
